(19) United States
(12) Patent Application Publication
(10) Pub. No.: US 2016/0292388 A1
(43) Pub. Date: Oct. 6, 2016

(54) SYSTEMS, DEVICES, AND METHODS FOR REMOTELY DISPENSING A BABY PACIFIER

(71) Applicant: Ryan John Lee, Potomac, MD (US)

(72) Inventor: Ryan John Lee, Potomac, MD (US)

(21) Appl. No.: 15/038,414

(22) PCT Filed: Nov. 21, 2014
(86) PCT No.: PCT/US14/66938

§ 371 Date: May 20, 2016

Related U.S. Application Data
(60) Provisional application No. 61/908,058, filed on Nov. 23, 2013.

(51) Int. Cl. G06F 19/00; A61J 17/00; B65D 83/00

(52) U.S. Cl. CPC G06F 19/3462; B65D 83/00; A61J 17/008

(57) ABSTRACT

Systems, devices, and methods are described that enable users to remotely dispense pacifier. Also described are systems, devices, and methods including a wireless, remote controlled pacifier dispensing device having a pacifier dispensing assembly and a pacifier dispensing module. In an embodiment, a pacifier dispensing module is operably coupled to the pacifier dispensing component, and is configured to dispense of at least one pacifier received within the pacifier dispensing component responsive to one or more signals from a client device.

### CROSS-REFERENCE TO RELATED APPLICATION

This application claims the benefit under 35 U.S.C. §119(e) of U.S. Provisional Patent Application No. 61/908,058 filed Nov. 23, 2013, which is herein incorporated by reference in its entirety.

### SUMMARY

In an aspect, the present disclosure is directed to, among other things, a wireless, remote controlled pacifier dispensing device. The pacifier dispensing device can be installed at a location suitable for dispensing pacifiers to a child. In some embodiments, the pacifier dispensing device can be attached to, for example, a crib, a bed, a playpen, or the like. The pacifier dispensing device can be filled with one or more pacifiers that can be selectively dispensed by the pacifier dispensing device. For example, if a child loses a pacifier (e.g., a pacifier falls out of a crib), the pacifier dispensing device can dispense another pacifier into the crib. The child can retrieve and use the dispensed pacifier. In some remote-controlled embodiments, a user (e.g., a parent, a babysitter, etc.) can control the pacifier dispensing device to dispense one pacifier at a time. The user can be located outside of the child's room or at another location to avoid disrupting the child. The pacifier dispensing device can include one or more cameras, microphones, sensors (e.g., thermometers) that can be used to determine whether to dispense a pacifier. The user can monitor child and dispense pacifiers as needed without entering the room and disrupting the child's sleep routine.

In an aspect, the present disclosure is directed to, among other things, a wireless, remote controlled pacifier dispensing device. In an embodiment, the remote controlled pacifier delivery device includes a pacifier dispensing component. In an embodiment, the pacifier dispensing component is removable and may be attached to a portion of a crib, a bed, or playpen. In an embodiment, the pacifier dispensing component is configured to activate the dispensing of at least one pacifier received within the pacifier dispensing component. In an embodiment, the pacifier dispensing component is configured to activate dispensing of at least one pacifier received within the pacifier dispensing component responsive to one or more signals from a client device, remote controller, an associated device, and the like.

In an aspect, the present disclosure is directed to, among other things, a wireless, remote controlled pacifier dispensing device including a baby monitoring camera for capturing and communication real-time video information. For example, in an embodiment, a remote controlled pacifier dispensing device includes a baby monitoring camera for capturing real-time video and transmitting said video to a remote monitor, sensor component, and a microphone for capturing audio and transmitting said audio to a remote monitor. In an embodiment, the remote controlled pacifier dispensing device includes a camera coupled to said device capable of transmitting black and white or color video to a remote monitor. In an embodiment, the remote controlled pacifier dispensing device includes a microphone coupled to said device capable of transmitting audio to a remote monitor, client device, associated device, and the like.

In an aspect, the present disclosure is directed to, among other things, a wireless, remote controlled pacifier dispensing device including a camera and/or microphone modules. In an embodiment, the wireless pacifier dispensing unit includes a music module operably coupled to said device for the playing of pre-programmed or remotely transmitted music selections. In an embodiment, the wireless pacifier dispensing unit includes a music module capable of receiving a signal from a remote control unit to change current music selection. In an embodiment, the wireless pacifier dispensing unit includes a music module capable of receiving a signal from a remote control unit to lower or raise decibel level. In an embodiment, the wireless pacifier dispensing unit includes a speaker module operably coupled to the device configured to emit the audio from the music component.

In an aspect, the present disclosure is directed to, among other things, a wireless, remote controlled pacifier dispensing device. In an embodiment, the wireless, remote controlled pacifier dispensing unit includes an infrared thermometer operably coupled to the device and configured to take readings, such as an internal temperature reading of a child (e.g., infant, toddler, kid, and the like) that may be in a crib, a bed, or playpen. In an embodiment, the infrared thermometer module can be adapted to transmit an internal temperature reading of a child to a remote control which is configured to display said reading. In an embodiment, the infrared thermometer module can be configured to transmit a temperature reading to the display on a remote control unit in Celsius and/or Fahrenheit degrees.

In an aspect, the present disclosure is directed to, among other things, a wireless, remote controlled pacifier dispensing device. In an embodiment, the wireless, remote controlled pacifier dispensing unit includes a thermometer operably coupled to the device and configured to take a temperature reading of a room. In an embodiment, the thermometer module will be adapted to transmit a temperature reading of a room to a remote control which is configured to display said reading. In an embodiment, the thermometer module will be configured to transmit a temperature reading to the display on a remote control unit in Celsius and/or Fahrenheit degrees. In an embodiment, the thermometer module will be configured to transmit a warning signal to a remote control unit should a room temperature fall below a pre-set setting.

In an aspect, the present disclosure is directed to, among other things, a wireless, remote controlled pacifier dispensing device. In an embodiment, the remote controlled pacifier delivery device includes a pacifier dispensing component. In an embodiment, the pacifier dispensing component is removable and may be attached to a portion of a crib, a bed, or playpen. In an embodiment, the pacifier dispensing component is configured to activate the dispensing of at least one medicine dispensing pacifier received within the pacifier dispensing component. In an embodiment, the pacifier dispensing component is configured to activate dispensing of at least one medicine dispensing pacifier received within the pacifier dispensing component responsive to one or more signals from a remote controller.

In an aspect, the present disclosure is directed to, among other things, a remote controlled pacifier dispensing device. In an embodiment, remote controlled pacifier dispensing device includes a pacifier dispensing component. In an embodiment, the pacifier dispensing component is removably detachable to a portion of a crib, a bed, or playpen. The pacifier dispensing component can be configured to retain one or more pacifiers. In an embodiment, the pacifier dispensing component is configured to dispense at least one pacifier responsive to one or more signals from a client device. In an embodiment, the remote controlled pacifier dispensing device includes a pacifier dispensing module operably coupled to the pacifier dispensing component. The pacifier dispensing module can be configured to dispense of at least one pacifier received within the pacifier dispensing component responsive to one or more signals from a remote controller.

In an aspect, the present disclosure is directed to, among other things, a wireless, remote controlled pacifier dispensing device. In an embodiment, the remote controlled pacifier dispensing device includes a pacifier dispensing assembly removably detachable to a portion of a crib, a bed, or playpen. In an embodiment, the pacifier dispensing assembly is configured to retain and dispense one or more pacifiers. In an embodiment, the pacifier dispensing assembly is configured to dispense at least one pacifier responsive to one or more signals from a client device. In an embodiment, the pacifier dispensing assembly is configured to dispense at least one pacifier responsive to one or more signals from a remote controller. In an embodiment, the remote controlled pacifier dispensing device includes a pacifier dispensing module operably coupled to the pacifier dispensing assembly. In an embodiment, the pacifier dispensing module includes circuitry configured to activate the release of at least one pacifier received within the pacifier dispensing assembly responsive to one or more signals from a client device.

In an aspect, the present disclosure is directed to, among other things, a method for remotely dispensing a pacifier. In an embodiment, the method for remotely dispensing a pacifier includes negotiating an authorization protocol with a client device. In an embodiment, the method for remotely dispensing a pacifier includes dispensing of at least one pacifier received within a pacifier dispensing assembly responsive to one or more control signals from a client device. In an embodiment, the method for remotely dispensing a pacifier includes receiving one or more control commands from the client device. In an embodiment, the method for remotely dispensing a pacifier includes receiving one or more control commands from the client device indicative of a pacifier dispense condition (e.g., image data indicative that child is awake, sensor data indicative that child is crying, program data indicative that a target time for dispensing pacifiers has occurred, etc.). In an embodiment, the method for remotely dispensing a pacifier includes exchanging information with a client device indicative of a pacifier dispense condition. In an embodiment, the method for remotely dispensing a pacifier includes exchanging information indicative of a child status. In an embodiment, the method for remotely dispensing a pacifier includes exchanging image, video, or audition information with a client device indicative of a child status.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a perspective view of a pacifier dispensing system according to one embodiment

FIG. 2 is a perspective view of a pacifier dispensing system according to one embodiment.

FIG. 3 is a perspective view of a pacifier dispensing system according to one embodiment.

FIG. 4 is a perspective view of a pacifier dispensing system according to one embodiment.

FIG. 5 is a perspective view of a pacifier dispensing system according to one embodiment.

FIG. 6 is a perspective view of a pacifier dispensing system according to one embodiment.

FIG. 7 is a perspective view of a pacifier dispensing system according to one embodiment.

FIG. 8 is a perspective view of a pacifier dispensing system according to one embodiment.

FIG. 9 is a perspective view of a pacifier dispensing system according to one embodiment.

FIG. 10 is a perspective view of a pacifier dispensing system according to one embodiment.

FIG. 11 shows a flow diagram of a method for remotely dispensing a pacifier according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

With new guidelines to parents advising to not use bumpers in cribs, a child's pacifier easily rolls out between the crib rails. Many children go to bed with a pacifier and they often lose the pacifier just before they fall asleep or a baby awakes early from a nap or earlier than normal in the morning, and all they need is the lost pacifier to be comforted. If a parent comes into the room to provide a new pacifier, the child may see the parent and now wants out of the crib. In an embodiment, one or more methodologies or technologies describe herein are configured to dispense a pacifier via remote control into a crib, a bed, or playpen. For example, in an embodiment, a pacifier dispensing system drops a second, backup pacifier via remote control into a crib, a bed, or playpen when a child has lost the one they were laid down with. In some embodiments, the pacifier dispensing system is capable of dispensing one more pacifiers responsive to a signal from a wireless controller. The wireless controller can be at a remote location so that the child does not see the parent.

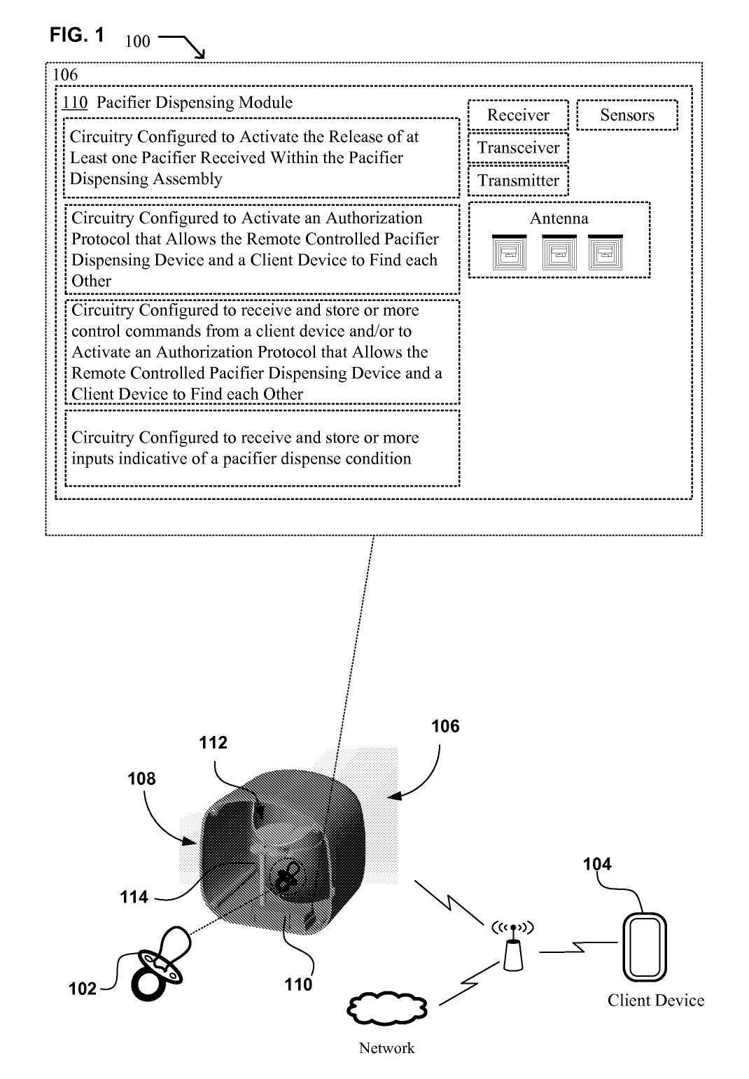

FIG. 1 shows a pacifier dispensing system 100 in which one or more methodologies or technologies can be implemented such as, for example, dispensing one more pacifiers 102 responsive to a signal or an authorization input from a client device 104. Non-limiting examples of client devices 104 include smart devices, smart eyewear devices, smart wearable devices, and the like. Further non-limiting examples of client devices 104 include cell phone devices, computer devices, desktop computer devices, laptop computer devices, managed node devices, notebook computer devices, remote controllers, tablet devices, wearable devices, application interface with smart devices, and the like. Further non-limiting examples of client devices 104 include mobile client devices.

In an embodiment, a pacifier dispensing system 100 includes one or more pacifier dispensing devices 106. In an embodiment, a pacifier dispensing device 106 includes a portion that is removably detachable to a portion of a crib, a bed, or playpen. In an embodiment, a pacifier dispensing device 106 includes one or more pacifier dispensing assemblies 108. In an embodiment, the pacifier dispensing assembly 108 is configured to retain and dispense one or more pacifiers 102. In an embodiment, the pacifier dispensing assembly 108 is configured to dispense at least one pacifier 102 responsive to one or more signals from a client device 104.

In an embodiment, the pacifier dispensing assembly 108 is configured to dispense at least one pacifier 102 responsive to one or more signals from a cell phone device, a computer device, a desktop computer device, a laptop computer device, a managed node device, a notebook computer device, a remote controller, a tablet device, a wearable device, an application interface with smart device, and the like. In an embodiment, the pacifier dispensing assembly 108 is configured to dispense at least one pacifier 102 responsive to one or more signals from a mobile client device. In an embodiment, the pacifier dispensing assembly 108 is configured to dispense at least one pacifier 102 responsive to one or more signals from a remote controller. In an embodiment, the pacifier dispensing assembly 108 is configured to dispense at least one pacifier 102 responsive to one or more signals from a wireless remote control device.

In an embodiment, a pacifier dispensing device 106 includes a pacifier dispensing module 110 operably coupled to the pacifier dispensing assembly 108. In an embodiment, the pacifier dispensing assembly 108 is configured to dispense at least on pacifier 102 responsive to one or more inputs from the pacifier dispensing module 110. For example, in an embodiment, the pacifier dispensing module 110 includes circuitry configured to activate the release of at least one pacifier 102 received within the pacifier dispensing assembly 108 responsive to one or more signals from a client device 104.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), or the like, or any combinations thereof, and can include discrete digital or analog circuit elements or electronics, or combinations thereof. In an embodiment, circuitry includes one or more ASICs having a plurality of predefined logic components. In an embodiment, circuitry includes one or more FPGA having a plurality of programmable logic components.

In an embodiment, the pacifier delivery device 106 includes circuitry having one or more components operably coupled (e.g., communicatively, electromagnetically, magnetically, ultrasonically, optically, inductively, electrically, capacitively coupled, or the like) to each other. In an embodiment, circuitry includes one or more remotely located components. In an embodiment, remotely located components are operably coupled via wireless communication. In an embodiment, remotely located components are operably coupled via one or more receivers, transceivers, or transmitters, or the like.

In an embodiment, circuitry includes one or more memory devices that, for example, store instructions or data. For example, in an embodiment, the pacifier delivery device 106 includes one or more memory devices that store image information, reference control information, sensor information, object identification information, electrical property information, and the like. Non-limiting examples of one or more memory devices include volatile memory (e.g., Random Access Memory (RAM), Dynamic Random Access Memory (DRAM), or the like), non-volatile memory (e.g., Read-Only Memory (ROM), Electrically Erasable Programmable Read-Only Memory (EEPROM), Compact Disc Read-Only Memory (CD-ROM), or the like), persistent memory, or the like. Further non-limiting examples of one or more memory devices include Erasable Programmable Read-Only Memory (EPROM), flash memory, or the like. The one or more memory devices can be coupled to, for example, one or more computing devices by one or more instructions, data, or power buses.

In an embodiment, the pacifier delivery device 106 includes one or more memory device that stores, for example, image information, reference control information, sensor information, object identification information, and the like. In an embodiment, circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In an embodiment, circuitry includes one or more user input/output components that are operably coupled to at least one computing device to control (electrical, electromechanical, software-implemented, firmware-implemented, or other control, or combinations thereof) at least one parameter associated with, for example, with receiving one or more control commands from the client device 104 indicative of a pacifier dispense condition (e.g., image data indicative that child is awake, sensor data indicative that child is crying, program data indicative that a target time for dispensing pacifiers has occurred, etc.).

In an embodiment, circuitry includes a computer-readable media drive or memory slot that is configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as a magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., receiver, transceiver, or transmitter, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CDRW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

In an embodiment, pacifier delivery device 106 includes circuitry having one or more modules optionally operable for communication with one or more input/output components that are configured to relay user output and/or input. In an embodiment, a module includes one or more instances of electrical, electromechanical, software-implemented, firmware-implemented, or other control devices. Such devices include one or more instances of memory, computing devices, antennas, power or other supplies, logic modules or other signaling modules, gauges or other such active or passive detection components, piezoelectric transducers, shape memory elements, micro-electro-mechanical system (MEMS) elements, or other actuators. In an embodiment, the pacifier dispensing module 110 includes circuitry configured to activate an authorization protocol that allows the remote controlled pacifier dispensing device 106 and a client device 104 to find each other and negotiate one or more pre-shared keys.

In an embodiment, the pacifier dispensing module 110 includes at least one receiver, transceiver, or transmitter. In an embodiment, the pacifier dispensing module 110 includes one or more image, video, or audio sensors. In an embodiment, the pacifier dispensing module 110 includes is configured to activate an authorization protocol that allows the remote controlled pacifier dispensing device and the remote controller to find each other and negotiate one or more pre-shared keys. In an embodiment, the pacifier dispensing module 110 includes circuitry configured to receive and store one or more control commands from a client device 104. In an embodiment, the pacifier dispensing module 110 includes circuitry configured to receive and store one or more inputs indicative of a pacifier dispense condition.

Referring to FIG. 1, in an embodiment, during operation, responsive to a control command from a client device 104, the pacifier dispensing device 106 dispenses at least one pacifier 102 received in pacifier dispensing assembly 106 having a passageway 112, through an opening 121 on the pacifier dispensing device 106. In an embodiment, a passageway structure curves near a dispensing portion so as to project a dispensing pacifier towards a region with the crib, bed, playpen, etc. so that a dispensed pacifier does not roll backwards, away, or out of the crib, bed, playpen, etc.

In an embodiment, a pacifier dispensing device 106 comprises a plastic, pod shaped device that may be attached via one or more straps (e.g., hook and loop straps, fasteners, adhesives, and the like) to the vertical and horizontal bars of a crib rail. In an embodiment, one more pacifiers 102 are inserted into an opening 120 in the devices 106 at the top of the pod where a pacifier 102 then sits within an internal cylinder suspended on a plate, the plate holds one or more pacifiers 102 near the top of the pod. The plate release is adapted to be wirelessly triggered via a remote control at a distance whereas the pacifier 102 will then fall through the cylinder, dropping into the lower portion of the pod's interior cylinder and then sliding out of an opening 121 at the base of the device 106. In an embodiment, an opening 121 is located at the bottom of the device 106 and the internal cylinder from which the pacifier 102 ejects is oriented at an angle that allows the pacifier 102 to roll forward toward the center of the crib.

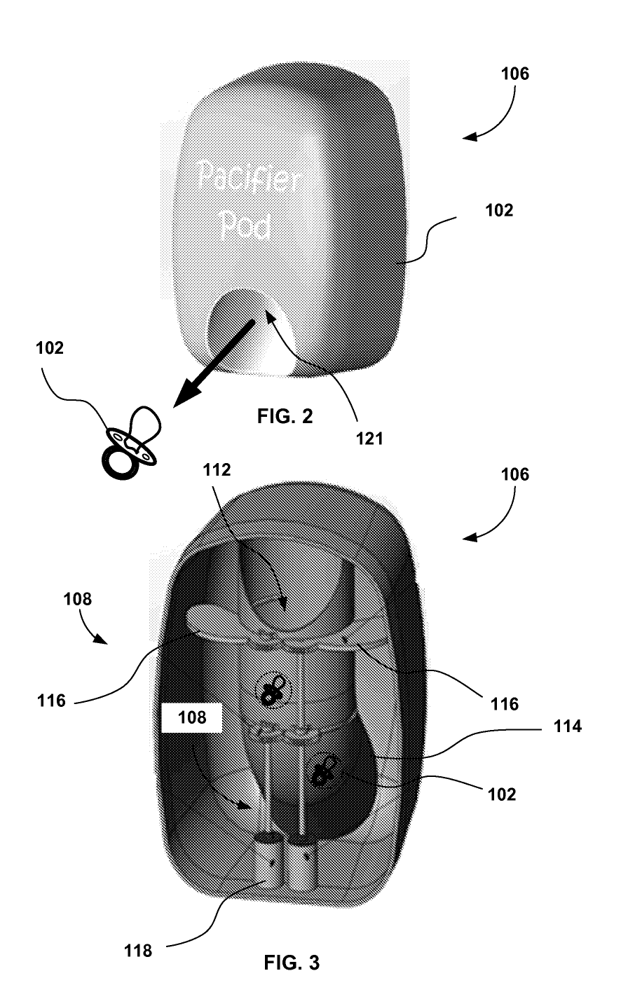

FIGS. 2 and 3 shows the inner workings of pacifier dispensing system 100 in which one or more methodologies or technologies can be implemented such as, for example, dispensing one or more pacifiers 102 received within. In an embodiment, one or more pacifiers are retained within a pacifier dispensing assembly 108 having an inner structure 114 defining at least one passageway 112 and one or more retention members 116. In an embodiment, one or more motors 118 actuate one or more cogs attached retention members 116 to move in a way to allow a pacifier 102 to be dispensed out of the inner structure 114. In an embodiment, when the retention members 116 are displaced by the motor 118, a pacifier 102 received within the inner structure 114 is dispense out of the inner structure 114, and exists through an opening 120 on the pacifier dispensing device 106.

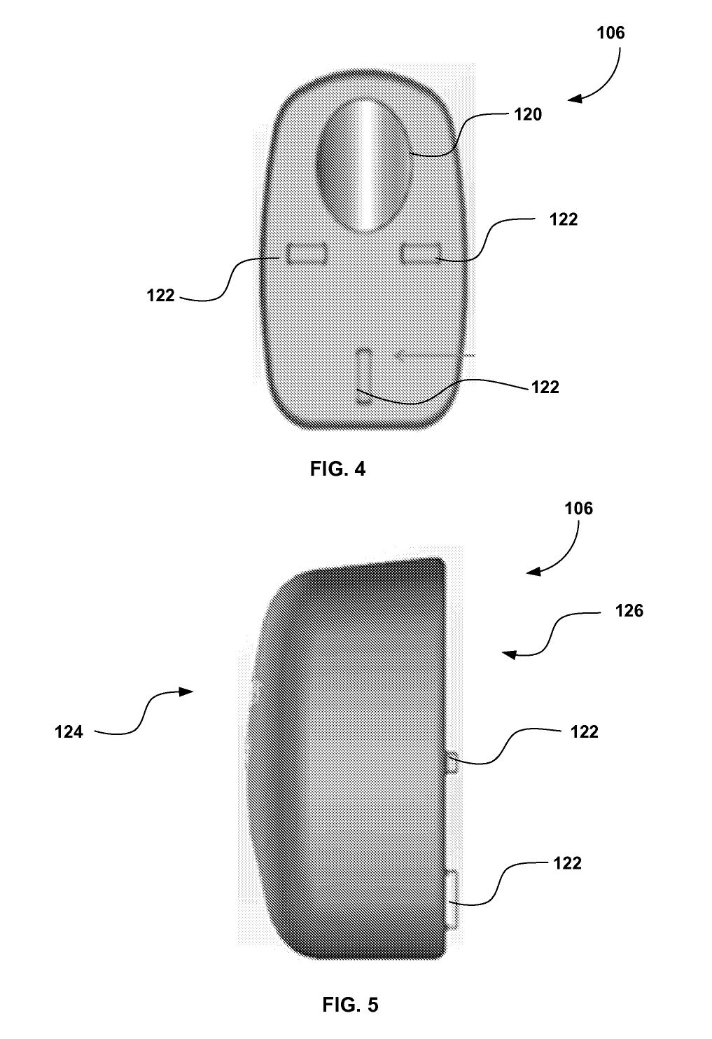

FIGS. 4 through 8 show one or more pacifier dispensing devices 106 in which one or more methodologies or technologies can be implemented such as, for example, dispensing at least one pacifier 102 received in pacifier dispensing assembly 108 responsive to receiving one or more signals from a remotely located client device 104. In an embodiment, pacifiers are loaded though an opening 120. In an embodiment, opening 120 includes a cover. In an embodiment, opening 120 includes a remotely actuatable cover. In an embodiment, the opening 120 for loading the pacifier dispensing device 106 sits above a crib's rail to allow access to fill the pacifier dispensing device 106 with pacifiers 102. In an embodiment, the pacifier dispensing device 106 includes one or more attachment points 122 for physically coupling the pacifier dispensing device 106 to a portion of the crib, bed, playpen, etc. In an embodiment, the pacifier dispensing device 106 forms an integral part of a crib, bed, playpen, etc. In an embodiment, the pacifier dispensing device 106 is attached to a crib, bed, playpen, etc. with one or more fasteners, VELCRO straps, straps, belts, adhesive structures, etc. In an embodiment, the pacifier dispensing device 106 is attached to a crib, bed, playpen, etc. with one or more VELCRO straps that are threaded at the one or more attachment points 122. In an embodiment, at least two straps are fixed so as to attach to a portion of a crib rail. For example, in an embodiment, at least two straps are fixed vertically so as to attach to the top, horizontal crib rail. In an embodiment, a third, lower strap, is attached horizontally and wraps around a perpendicular crib rain between the two top straps.

FIG. 5 shows a side view a pacifier dispensing device 106 according to one embodiment. In an embodiment, the pacifier dispensing device 106 comprises an inner crib, bed, or playpen side 124; and a crib, bed, or playpen coupling side 126. In an embodiment, the crib, bed, or playpen coupling side 126 is the portion that is affixed to the crib rail, a crib portion, a bed portion, or playpen portion.

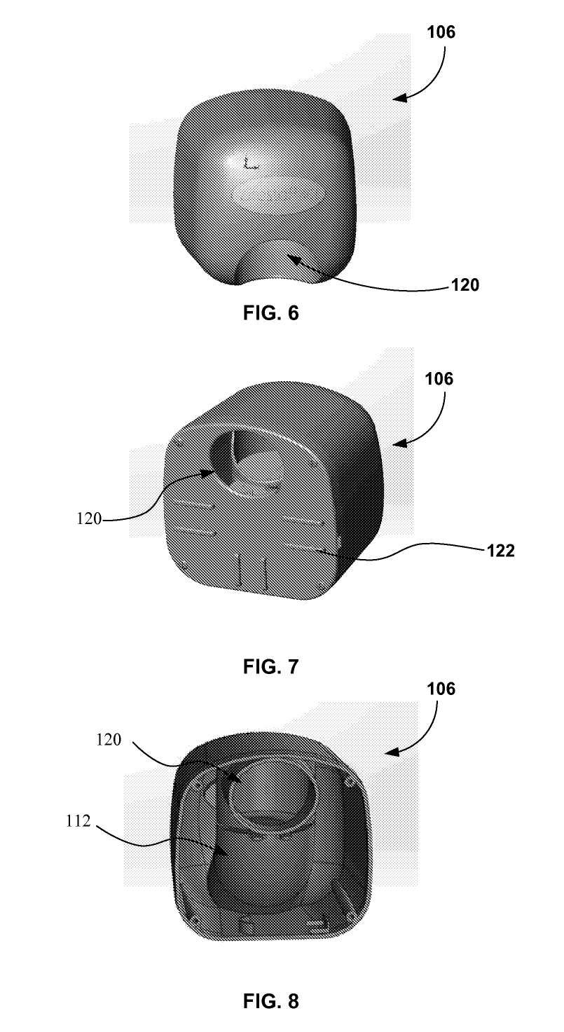

Referring to FIG. 6, in an embodiment, a wireless, remote controlled pacifier dispensing device 106 includes, among other things, a pacifier dispensing component 128. In an embodiment, the pacifier dispensing component 128 is removably detachable to a portion of a crib, a bed, or playpen. In an embodiment, the pacifier dispensing component 128 is configured to retain one or more pacifiers 102.

In an embodiment, the pacifier dispensing component 128 is configured to dispense at least one pacifier 102 responsive to one or more signals from a cell phone device, a computer device, a desktop computer device, a laptop computer device, a managed node device, a notebook computer device, a remote controller, a tablet device, a wearable device, an application interface with smart device, and the like. In an embodiment, the pacifier dispensing component 128 is configured to dispense at least one pacifier 102 responsive to one or more signals from a mobile client device. In an embodiment, the pacifier dispensing component 128 is configured to dispense at least one pacifier 102 responsive to one or more signals from a remote controller. In an embodiment, the pacifier dispensing component 128 is configured to dispense at least one pacifier 102 responsive to one or more signals from a wireless remote control device.

In an embodiment, a pacifier dispensing device 106 includes a pacifier dispensing module 110 operably coupled to the pacifier dispensing component 128. In an embodiment, the pacifier dispensing component 128 is configured to dispense at least on pacifier 102 in response to one or more inputs from the pacifier dispensing module 110. In an embodiment, the pacifier dispensing component 128 is attachable to a portion of a crib, a bed, or playpen. In an embodiment, the pacifier dispensing component is configured to retain one or more pacifiers 102. In an embodiment, a wireless, remote controlled pacifier dispensing device 106 includes, among other things, a pacifier dispensing module 110. In an embodiment, the pacifier dispensing module 110 is operably coupled to the pacifier dispensing component 128. In an embodiment, the pacifier dispensing module 110 is configured to activate the dispensing of at least one pacifier 102 received within the pacifier dispensing component 128 responsive to one or more signals from a remote controller.

In an embodiment, the pacifier dispensing module 110 includes at least one receiver, transceiver, or transmitter. In an embodiment, the pacifier dispensing module 110 one or more image, video, or audio sensors. In an embodiment, the pacifier dispensing module 110 is configured to activate an authorization protocol that allows the remote controlled pacifier dispensing device 106 and the remote controller to find each other and negotiate one or more pre-shared keys.

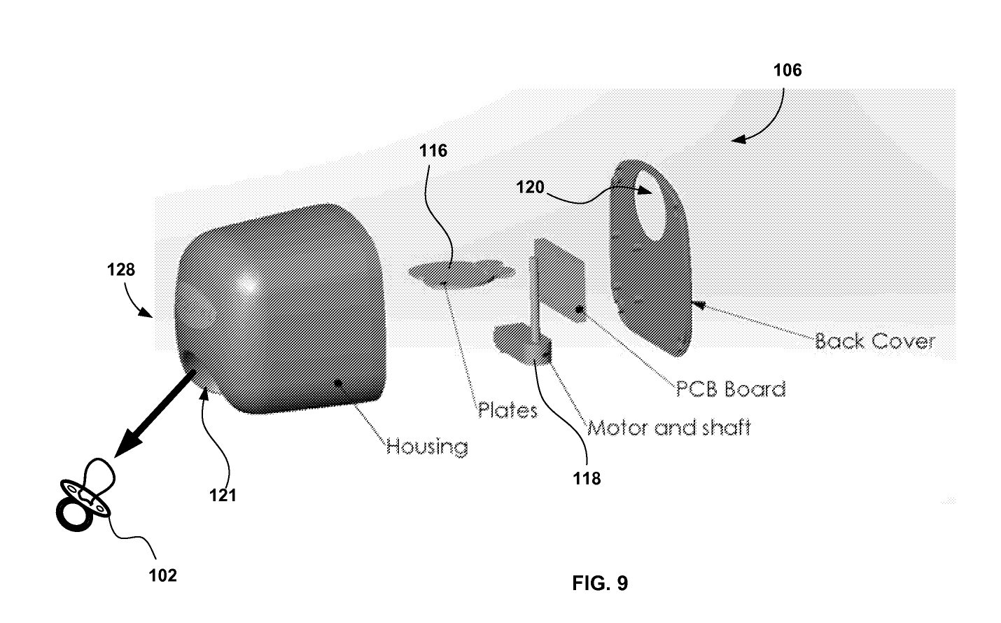

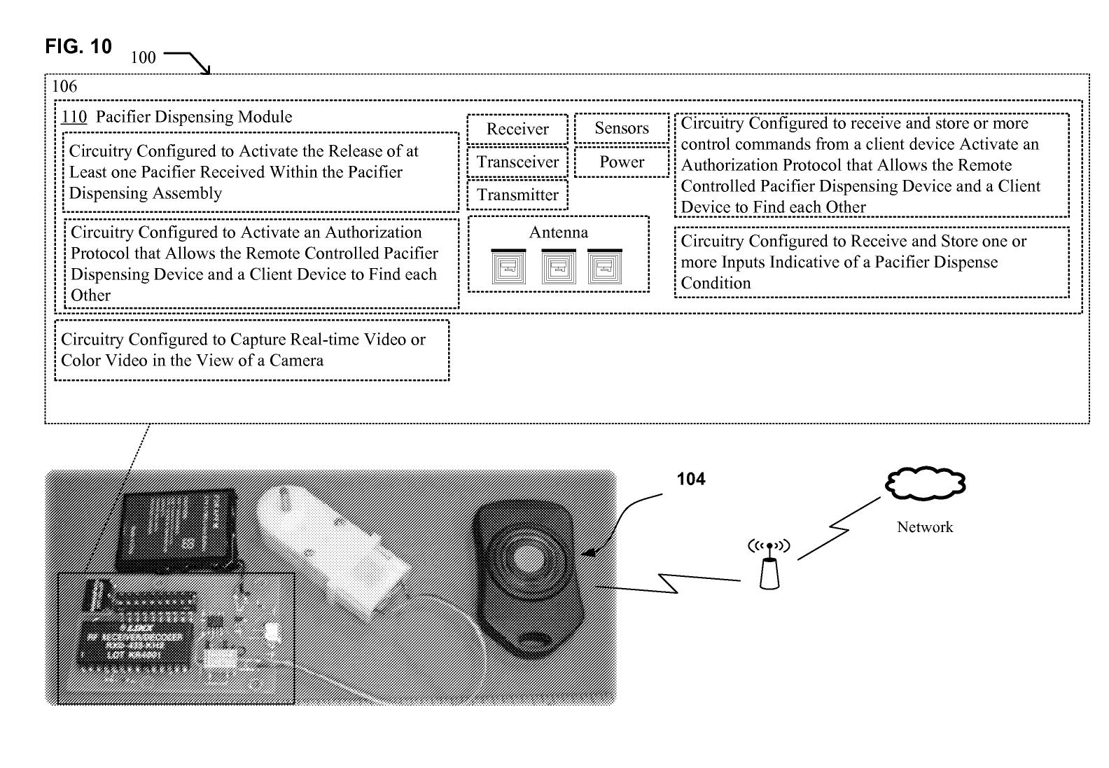

Referring to FIGS. 9 and 10, in an embodiment, the pacifier dispensing module 110 includes circuitry configured to receive and store one or more control commands from a client device 104. In an embodiment, the pacifier dispensing module 110 circuitry configured to receive and store one or more inputs indicative of a pacifier dispense condition. In an embodiment, the pacifier dispensing component 128 includes a baby monitoring camera operably coupled to the pacifier dispensing component for capturing real-time video in the view of said camera. In an embodiment, the camera module is configured to transmit the video to a remote monitor.

In an embodiment, the pacifier dispensing component 128 includes a microphone operably coupled to the pacifier dispensing component 128 for capturing real time audio. In an embodiment, the microphone module is configured to transmit the audio to a remote monitor. In an embodiment, the pacifier dispensing component 128 includes a music module operably coupled to the pacifier dispensing component 128. In an embodiment, the music module is configured to activate the playing of pre-programmed or remotely feed music selections and responsive to one or more signals from a remote controller.

In an embodiment, the pacifier dispensing component 128 includes a speaker module operably coupled to the pacifier dispensing component 128. In an embodiment, the speaker module is configured to emit the music at desired decibel levels. In an embodiment, the pacifier dispensing component 128 includes an infrared thermometer component operably coupled to the pacifier dispensing device 106. In an embodiment, the infrared thermometer is configured to take an internal temperature reading of a child that is in a crib, a bed, or playpen and transmit said reading to a remote control which is configured to display said reading.

In an embodiment, the pacifier dispensing component 128 includes thermometer module operably coupled to the pacifier dispensing device 106. In an embodiment, the thermometer is configured to take a temperature reading of the room and transmit said reading to a remote control which is configured to display said reading. In an embodiment, the pacifier dispensing component 128 is attachable to a portion of a crib, a bed, or playpen. In an embodiment, the pacifier dispensing component 128 is configured to retain one or more medicine dispensing pacifiers 102. In an embodiment, the pacifier dispensing module 110 is operably coupled to the pacifier dispensing component 128.

In an embodiment, the pacifier dispensing module 110 is configured to activate the dispensing of at least one medicine dispensing pacifier received within the pacifier dispensing component 128 responsive to one or more signals from a remote controller. In an embodiment, a wireless, remote controlled pacifier delivery device 106 includes a crib, a bed, or playpen mountable unit having a pacifier delivery apparatus. In an embodiment, the pacifier delivery apparatus is operable to house one or more pacifiers 102 and a remote control unit.

In an embodiment, the remote pacifier delivery device 106 is adapted and configured to allow a two-way wireless communication between the remote control unit and a crib, a bed, or playpen mounted device 106. In an embodiment, the two-way wireless communication is between said remote control unit and said pacifier delivery device 106. In an embodiment, the remote control unit includes one or more switches independently operating the release for pacifier 1 and pacifier 2, which will exit the base of the crib mounted unit and roll to the center of the crib. In an embodiment, the pacifier unit includes a baby monitoring device 106. In an embodiment, the baby monitoring device 106 includes circuitry configured to capture real-time video or color video in the view of a camera.

In an embodiment, Z remote control unit includes a speaker for playing an audio corresponding to audio captured by a microphone of said crib mobile or said monitor unit. In an embodiment, the pacifier delivery device 106 remote control unit includes a video display for displaying a video or a color video corresponding to video or color video captured by a camera of said pacifier delivery device 106 or said baby monitor unit.

In an embodiment, the pacifier delivery device 106 comprises a plurality of controls at said remote control unit and/or said baby monitor unit via which a user can provide instructions to said pacifier delivery device unit for operation thereof. In an embodiment, a pacifier delivery device 106 that includes a speaker for playing a pre-programmed music and/or remotely feed music and a microphone for capturing audio from the surrounding of said speaker. In an embodiment, a pacifier delivery device 106 includes a camera for capturing video or color video in the view of said camera. In an embodiment, the remote control unit includes a speaker for playing an audio corresponding to audio captured by a microphone of said pacifier pod unit.

In an embodiment, a pacifier delivery device 106 includes a remote control unit having a video display for displaying a video or a color video corresponding to video or color video captured by a camera of said pacifier pod unit. In an embodiment, the pacifier pod unit has capability of ejecting pacifiers 102 holding medicine.

In an embodiment, a pacifier delivery device 106 includes an infrared thermometer to scan the baby's temperature and transmit to a client device 104 such as a remote control unit.

In an embodiment, a pacifier delivery device 106 includes a client device 104 having a video display for displaying temperature reading from pacifier unit's infrared thermometer. In an embodiment, a pacifier delivery apparatus further comprises a plurality of controls at said remote control unit and said pacifier delivery apparatus via which a user can provide instructions to said pacifier pod unit for operation thereof.

In an embodiment, a pacifier delivery device 106 includes a housing. In an embodiment, a main function of the housing is to hold all other components that allow the pacifier delivery device 106 to work. In an embodiment, to load the pacifier delivery device 106, a pacifier 102 is place in an opening on the back of the housing where it rest on the retention members 116. The housing is designed to direct the pacifier towards the center of the crib when it is released. The housing also has features designed to hold the motor and retention members 116 assemblies securely. In an embodiment, a pacifier delivery device 106 includes a back cover that allows for Velcro straps to be secured to the outside of the cover. In addition the hole cut in the cover allows a pacifier to be inserted from the back of the device to load it. In an embodiment, the back cover also provides an area for the PCB board to be mounted securely.

In an embodiment, a pacifier delivery device 106 includes printed circuit board forming part of the pacifier dispensing module 110. In an embodiment, the printed circuit board comprises one or more electrical components, electro-mechanical components, electro-optical components, and the like. In an embodiment, the pacifier dispensing module 110 includes a receiver that control a small motor that is powered by a rechargeable lithium ion battery. In an embodiment, a remote controller and a receiver will communicate through multiple walls so that the user can control the pacifier delivery device 106 from across the house or from a different story within the house.

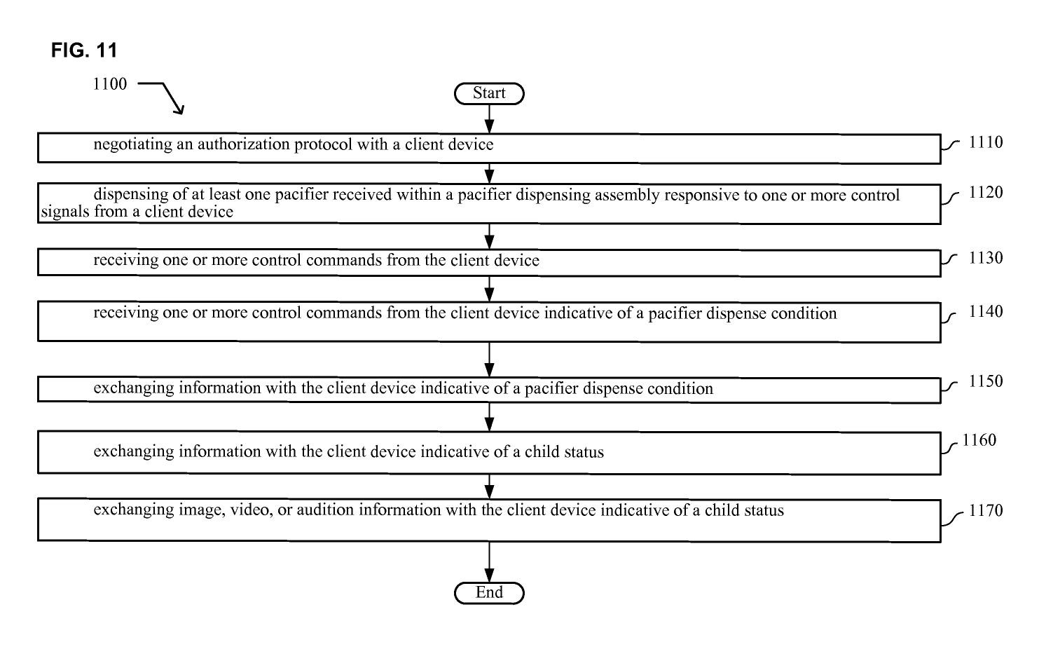

FIG. 11 shows a method 1100 for remotely dispensing a pacifier. At 1110, the method 1100 for remotely dispensing a pacifier includes negotiating an authorization protocol with a client device 104. At 1120, the method 1100 for remotely dispensing a pacifier includes dispensing of at least one pacifier received within a pacifier dispensing assembly 108 responsive to one or more control signals from a client device 104. At 1130, the method 1100 for remotely dispensing a pacifier includes receiving one or more control commands from the client device 104. At 1140, the method 1100 for remotely dispensing a pacifier includes receiving one or more control commands from the client device 104 indicative of a pacifier dispense condition. At 1150, the method 1100 for remotely dispensing a pacifier includes exchanging information with the client device 104 indicative of a pacifier dispense condition. At 1160, the method 1100 for remotely dispensing a pacifier includes exchanging information with the client device 104 indicative of a child status. At 1170, the method 1100 for remotely dispensing a pacifier includes exchanging image, video, or audition information with the client device 104 indicative of a child status.

The claims, description, and drawings of this application may describe one or more of the instant technologies in operational/functional language, for example as a set of operations to be performed by a computer. Such operational/functional description in most instances can be specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats tools in the form of a high-level programming language (e.g., C, java, visual basic), etc.), or tools in the form of Very high speed Hardware Description Language (“VIDAL,” which is a language that uses text to describe logic circuits)are generators of static or sequenced specifications of various hardware configurations. This fact is sometimes obscured by the broad term “software,” but, as shown by the following explanation, what is termed “software” is a shorthand for a massively complex interchanging/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., High-level Programming Language, Wikipedia. Wikimedia Foundation, 18 Jan. 2014. Web. 4 Feb. 2014. In order to facilitate human comprehension, in many instances, high-level programming languages resemble or even share symbols with natural languages. See, e.g., Natural Language, Wikipedia. Wikimedia Foundation, 14 Jan. 2014. Web. 4 Feb. 2014.

It has been argued that because high-level programming languages use strong abstraction (e.g., that they may resemble or share symbols with natural languages), they are therefore a “purely mental construct” (e.g., that “software” a computer program or computer programming is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational machines the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)the best known of which is the microprocessor. A modern microprocessor will often contain more than one hundred million logic gates in its many logic circuits (and often more than a billion transistors). See, e.g., Logic Gates, Wikipedia. Wikimedia Foundation, 2 Apr. 2014. Web. 4 Feb. 2014.

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Computer Architecture, Wikipedia. Wikimedia Foundation, 2 Feb. 2014. Web. 4 Feb. 2014.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Instructions per Second, Wikipedia. Wikimedia Foundation, 13 Jan. 2014. Web. 4 Feb. 2014.

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language the compiled version of the higher-level language functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, it can be recognizes that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

The state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc. in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably coupleable,” to each other to achieve the desired functionality. Specific examples of operably coupleable include, but are not limited to, physically mateable, physically interacting components, wirelessly interactable, wirelessly interacting components, logically interacting, logically interactable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “ a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A wireless, remote controlled pacifier dispensing device, comprising:
a pacifier dispensing component removably detachable to a portion of a at least one of a crib, a bed, and playpen, the pacifier dispensing component configured to retain one or more pacifiers; and
a pacifier dispensing module operably coupled to the pacifier dispensing component, the pacifier dispensing module configured to dispense of at least one pacifier received within the pacifier dispensing component responsive to one or more signals from a remote controller.

2. The wireless, remote controlled pacifier dispensing device of claim 1, wherein the pacifier dispensing component is configured to dispense at least one pacifier responsive to one or more signals from a client device.

3. The wireless, remote controlled pacifier dispensing device of claim 1, wherein the pacifier dispensing module includes at least one receiver, transceiver, or transmitter.

4. The wireless, remote controlled pacifier dispensing device of claim 1, wherein the pacifier dispensing module includes one or more image, video, or audio sensors.

5. The wireless, remote controlled pacifier dispensing device of claim 1, wherein pacifier dispensing module is configured to activate an authorization protocol that allows the remote controlled pacifier dispensing device and the remote controller to find each other and negotiate one or more pre-shared keys.

6. The wireless, remote controlled pacifier dispensing device of claim 1, wherein the pacifier dispensing module includes circuitry configured to receive and store one or more control commands from a client device.

7. The wireless, remote controlled pacifier dispensing device of claim 1, wherein the pacifier dispensing module includes circuitry configured to receive and store one or more inputs indicative of a pacifier dispense condition.

8. A wireless, remote controlled pacifier dispensing device, comprising:
a pacifier dispensing assembly removably detachable to a portion of a at least one of a crib, a bed, and playpen; and
a pacifier dispensing module operably coupled to the pacifier dispensing assembly.

9. The wireless, remote controlled pacifier dispensing device of claim 8, wherein the pacifier dispensing assembly is configured to retain and dispense one or more pacifiers.

10. The wireless, remote controlled pacifier dispensing device of claim 8, wherein the pacifier dispensing assembly is configured to dispense at least one pacifier responsive to one or more signals from a client device.

11. The wireless, remote controlled pacifier dispensing device of claim 8, wherein the pacifier dispensing assembly is configured to dispense at least one pacifier responsive to one or more signals from a remote controller.

12. The wireless, remote controlled pacifier dispensing device of claim 8, wherein the pacifier dispensing assembly is configured to dispense at least on pacifier responsive to one or more inputs from the pacifier dispensing module.

13. The wireless, remote controlled pacifier dispensing device of claim 8, wherein the pacifier dispensing module includes circuitry configured to activate the release of at least one pacifier received within the pacifier dispensing assembly responsive to one or more signals from a client device.

14. The wireless, remote controlled pacifier dispensing device of claim 8, wherein the pacifier dispensing module includes circuitry configured to activate an authorization protocol that allows the remote controlled pacifier dispensing device and a client device to find each other and negotiate one or more pre-shared keys.

15. A method for remotely dispensing a pacifier, comprising:
negotiating an authorization protocol with a client device; and
dispensing of at least one pacifier received within a pacifier dispensing assembly responsive to one or more control signals from a client device.

16. The method for dispensing a pacifier of claim 15, further comprising:
receiving one or more control commands from the client device.

17. The method for dispensing a pacifier of claim 15, further comprising:
receiving one or more control commands from the client device indicative of a pacifier dispense condition.

18. The method for dispensing a pacifier of claim 15, further comprising:
exchanging information with the client device indicative of a pacifier dispense condition.

19. The method for dispensing a pacifier of claim 15, further comprising:
exchanging information with the client device indicative of a child status.

20. The method for dispensing a pacifier of claim 15, further comprising:
exchanging image, video, or audition information with the client device indicative of a child status.
